(19) United States
(12) Patent Application Publication
(10) Pub. No.: US 2013/0290878 A1
(43) Pub. Date: Oct. 31, 2013

(54) GENERATION AND DISPLAY METHOD OF USER INTERFACE AND USER INTERFACE DEVICE

(71) Applicant: Huawei Technologies Co., Ltd., Shenzhen (CN)

(72) Inventor: Guozhu Li, Shenzhen (CN)

(73) Assignee: Huawei Technologies Co., Ltd., Shenzhen (CN)

(21) Appl. No.: 13/862,026

(22) Filed: Apr. 12, 2013

(30) Foreign Application Priority Data
Apr. 13, 2012 (CN) 201210108798.2

(51) Int. Cl. G06F 3/0481

(52) U.S. Cl. CPC G06F 3/0481
USPC 715/762

(57) ABSTRACT

The present invention is applicable to the field of electronics and provides a generation and display method of a user interface, and a user interface device. The method includes: determining an operable element of a user interface; generating a transition relationship connected graph of the operable element; and displaying the transition relationship connected graph in the user interface. Technical solutions provided by the present invention have the advantage of improving operational experience of a user.

### CROSS-REFERENCE TO RELATED APPLICATIONS

This application claims priority to Chinese Patent Application No. 201210108798.2, filed on Apr. 13, 2012, which is hereby incorporated by reference in its entirety.

### FIELD OF THE INVENTION

The present invention belongs to the field of communications, and in particular, relates to a generation and display technology of a user interface.

### BACKGROUND OF THE INVENTION

With the development of information technologies and electronic technologies, a user interface (User Interface, UI) is introduced in more and more fields. An existing UI is shown in FIG. 1 and includes a plurality of operable elements, such as a button 1, a button 2, a button 3, a button 4, a button 5, and a button 6 shown in FIG. I. The operable elements also include an option 1, an option 2, and an option 3. In addition, the operable elements may also include a link 1, a link 2, a link 3, and a link 4.

In a process of implementing the prior art, it is found that the technical solution in the prior art has the following problem:

When a user operates the existing user interface, especially when the user performs movements between a plurality of operable elements, the user can only determine a next connected element of a current focus according to a conjecture of the user, and the user cannot clearly know the next connected element of the current focus. For example, when the user performs sequential selection by using a Tab key, the user is not clear about the widget which is specifically selected.

### SUMMARY OF THE INVENTION

Embodiments of the present invention aim to provide a generation and display method of a user interface, so as to solve the problem that a user cannot clearly know a next connected element of a current focus in an existing technical solution.

In one aspect, the present invention provides a generation and display method of a user interface, where the method includes:

determining an operable element of a user interface;

generating a transition relationship connected graph of the operable element; and

displaying the transition relationship connected graph in the user interface.

In another aspect, a user interface device is provided, where the device includes:

a determining unit, configured to determine an operable element of a user interface;

a generating unit, configured to generate a transition relationship connected graph of the operable element; and

a displaying unit, configured to display the transition relationship connected graph in the user interface.

In a next aspect, a user equipment is provided, where the user equipment includes the above user interface device.

In the embodiments of the present invention, after the operable element of the user interface is determined in the technical solutions provided by the present invention, the transition relationship connected graph of the operable element is generated. Next, the transition relationship connected graph is displayed in the user interface. In this way, no matter which operable element a current focus is on, a next connected element of the current focus may be determined according to the transition relationship connected graph. Therefore, the technical solutions provided by the present invention have the advantage that the next connected element of the current focus is clearly known, and can improve operational experience of the user.

### BRIEF DESCRIPTION OF THE DRAWINGS

To describe the technical solutions in the embodiments of the present invention more clearly, the following briefly introduces the accompanying drawings needed for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a schematic display diagram of a user interface UI provided by the prior art;

FIG. 2 is a flow chart of a generation and display method of a user interface provided by an embodiment of the present invention;

FIG. 3 is a schematic display diagram of a user interface UI provided by an embodiment of the present invention;

FIG. 4 is another schematic display diagram of a user interface UI provided by an embodiment of the present invention;

FIG. 5 is yet another schematic display diagram of a user interface UI provided by an embodiment of the present invention;

FIG. 6 is a structural diagram of a user interface device provided by an embodiment of the present invention;

FIG. 7 is a flow chart of a generation and display method of a user interface of a navigator provided by an embodiment of the present invention; and

FIG. 8 is a schematic structural diagram of a user equipment provided by an embodiment of the present invention.

### DETAILED DESCRIPTION OF THE EMBODIMENTS

To make the objectives, technical solutions, and advantages of the present invention more comprehensible, the following further describes the present invention in detail with reference to the accompanying drawings and embodiment. It is understandable that the specific embodiment is merely used to explain the present invention and is not intended to limit the present invention.

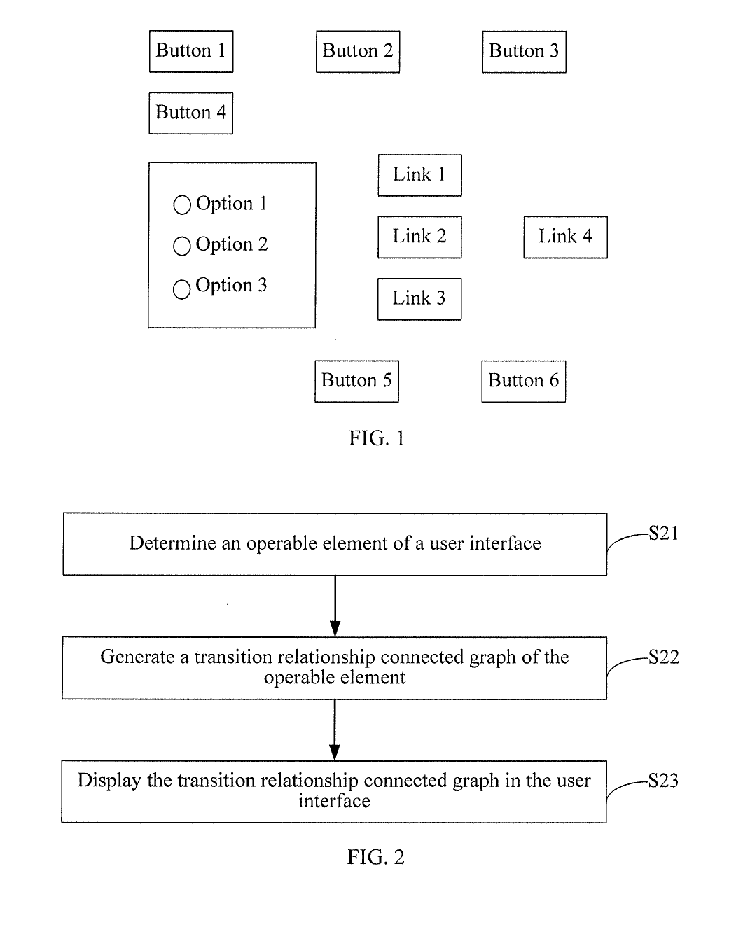

The present invention provides a generation and display method of a user interface. The method is executed by a user interface device, and the user interface device may be an electronic device that can display a user interface UI, for example, a computer, a server, a navigator, a tablet computer, or a mobile terminal. The method is shown in FIG. 2 and includes:

S21: Determine an operable element of a user interface.

S22: Generate a transition relationship connected graph of the operable element.

S23: Display the transition relationship connected graph in the user interface.

In the method provided by the present invention, after the operable element of the user interface is determined, the transition relationship connected graph of the operable element is generated. Next, the transition relationship connected graph is displayed in the user interface. In this way, no matter which operable element a current focus is on, a next connected element of the current focus may be determined according to the transition relationship connected graph. Therefore, the method provided by the present invention has the advantage that the next connected element of the current focus is clearly known, and can improve operational experience of a user.

It should be noted that the transition relationship connected graph may specifically include a step relationship navigation chart. That is, the transition relationship connected graph includes a schematic diagram of a focus movement between operable elements. The step relationship navigation chart is shown as dashed lines in FIG, 3.

It should be noted that, for an implementation method of the S23, any one of the following manners may specifically be adopted.

Manner A: Display, in the user interface, a transition relationship connected graph of all operable elements.

Manner B: Display, in the user interface, a transition relationship connected graph of an operable element corresponding to the current focus.

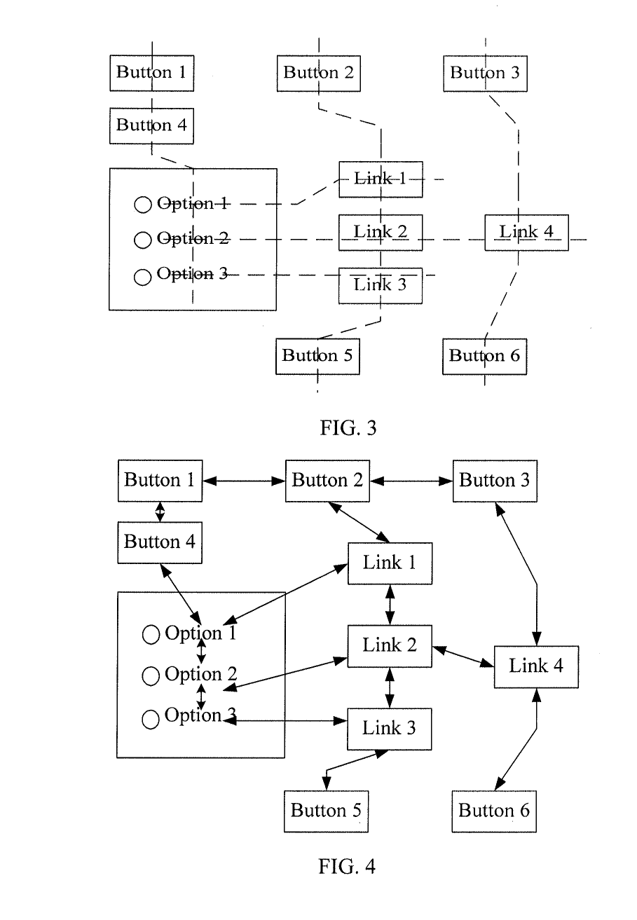

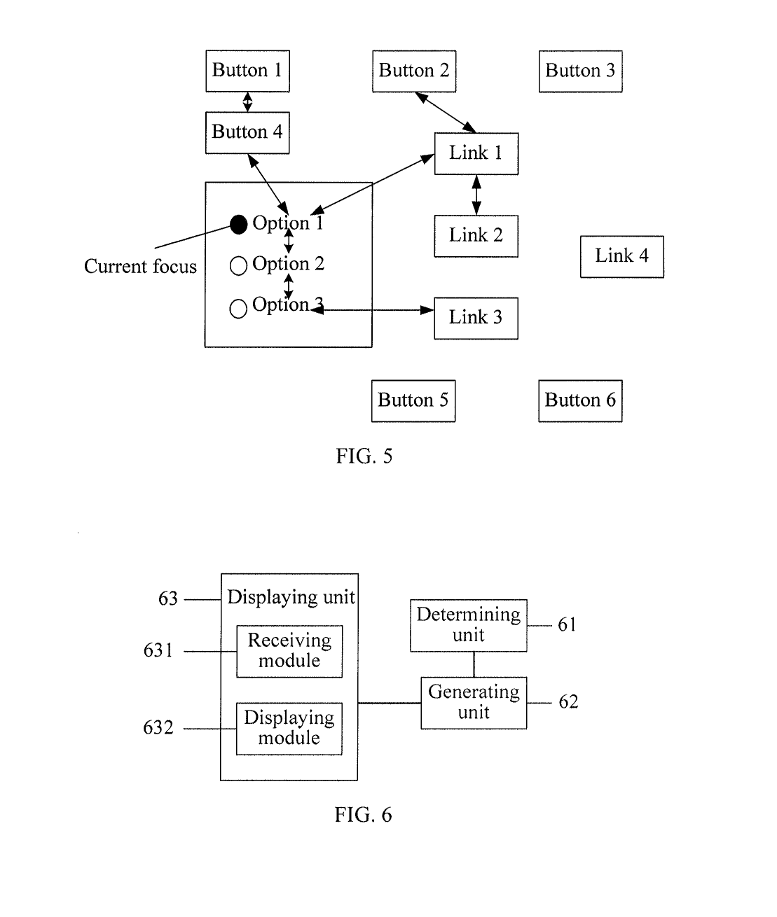

In addition, it should be noted that, for a display manner of the transition relationship connected graph in the manner A or the manner B, a plurality of manners may exist. For example, a dashed line manner shown in FIG. 3 is adopted to display the transition relationship connected graph. Definitely, other manners may also be adopted, for example, an arrow manner shown in FIG. 4 is adopted to display the transition relationship connected graph. Definitely, it may also be adopted, as shown in FIG. 5, that only the transition relationship connected graph of the operable element corresponding to the current focus is displayed (where the current focus in FIG. 5 is moved to an option 1). Definitely, the display manner may also be displaying the transition relationship connected graph in a flickering manner.

Optionally, the method for implementing S23 may also include:

receiving a display manner of the transition relationship connected graph, where the display manner of the transition relationship connected graph is input by the user, and displaying the transition relationship connected graph in the display manner selected by the user, where a specific method for implementing the manner may include: adding a display mode selection menu to the user interface, selecting, by the user, a favorite display manner in the menu, and then displaying, by a user equipment, the transition relationship connected graph according to the display manner selected by the user, where this manner may meet personalized requirements of the user, for example, the user may select the display manner of the manner A or the manner B, and definitely the user may also select a specific display manner, for example, the user may select a dashed line display manner shown in FIG. 3 or an arrow display manner shown in FIG. 4.

Optionally, after S23, the method may also include:

concealing the transition relationship connected graph when it is detected that the user does not operate the user interface in a set time, where this method may reduce influence of the connected graph on the user interface.

The present invention also provides a user interface device. The device is shown in FIG. 6 and includes:

a determining unit 61, configured to determine an operable element of a user interface;

a generating unit 62, configured to generate a transition relationship connected graph of the operable element; and a displaying unit 63, configured to display the transition relationship connected graph in the user interface.

Optionally, the displaying unit 63 is specifically configured to display, in the user interface, a transition relationship connected graph of all operable elements.

Optionally, the displaying unit 63 is specifically configured to display, in the user interface, a transition relationship connected graph of an operable element corresponding to a current focus.

Optionally, the displaying unit 63 specifically includes:

a receiving module 631, configured to receive a display manner of the transition relationship connected graph, where the display manner of the transition relationship connected graph is input by a user; and

a displaying module 632, configured to display the transition relationship connected graph in the display manner selected by the user.

Optionally, the user interface device may also specifically include:

a concealing unit 64, configured to conceal the transition relationship connected graph when it is detected that the user does not operate the user interface in a set time.

In addition, a specific implementation manner of the present invention also provides a user equipment. The user equipment includes the above user interface device, and the user equipment may specifically be an electronic device that can display a user UI, such as a computer, a server, a navigator, a tablet computer, or a mobile terminal.

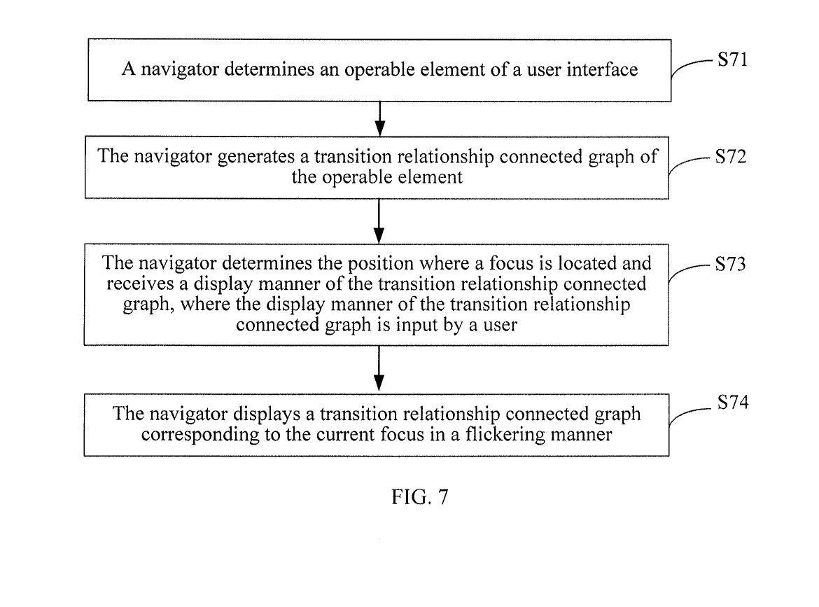

As shown in FIG. 7, it is a flow chart of a generation and display method of a user interface of a navigator provided by an embodiment of the present invention. A user equipment in this embodiment may be a navigator. This embodiment provides a generation and display method of a user interface of the navigator. The method is shown in FIG. 7 and includes:

S71: The navigator determines an operable element of the user interface.

S72: The navigator generates a transition relationship connected graph of the operable element.

S73: The navigator determines the position where a focus is located and receives a display manner of the transition relationship connected graph, where the display manner of the transition relationship connected graph is input by a user.

S74: The navigator displays a transition relationship connected graph of an operable element corresponding to the current focus in a flickering manner.

In the embodiment of the present invention, based on a navigation tool of the user interface (for example, a graphical user interface), one or more stack elements (for example, a directory) are presented and included in the user interface, and the stack element includes one or more operable elements.

Because a map exists in the user interface of the navigator, in order not to influence a visual effect of the map to the user, the transition relationship connected graph is displayed in a flickering manner in this embodiment.

A specific implementation manner of the present invention provides another embodiment. A user equipment in this embodiment may be a tablet computer or a mobile terminal. This embodiment provides a generation and display method of a user interface of a tablet computer. A difference between this embodiment and the foregoing embodiment lies in that the method in this embodiment is completed by a tablet computer or a mobile terminal. In addition, a display manner of the transition relationship connected graph may be the same as that in the foregoing embodiment, and may also be different from the display manner in the foregoing embodiment. For example, the transition relationship connected graph is displayed through arrows or dashed lines.

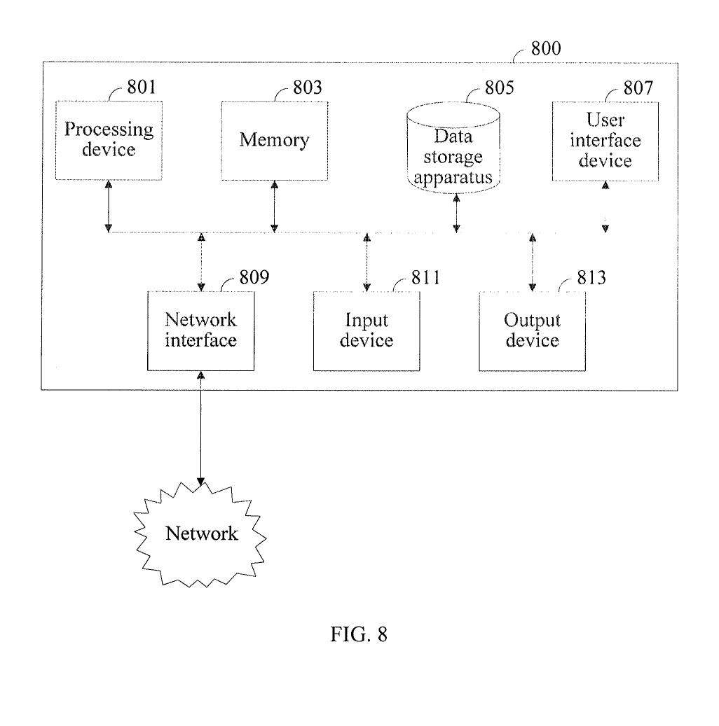

A schematic structural diagram of the user equipment 800 is shown in FIG. 8 and the user equipment 800 includes:

a processing device 801, a memory 803, a data storage apparatus 805, a user interface device 807, a network interface 809, an input device 811, and an output device 813, where each device is uniformly controlled by the processing device after being connected to a system bus, and the user interface device is configured to determine an operable element of a user interface; generate a transition relationship connected graph of the operable element; and display the transition relationship connected graph in the user interface.

Persons of ordinary skill in the art may be aware that, in combination with the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. Persons skilled in the art may use different methods to implement the described functions for each particular application, but it should not be considered that the implementation goes beyond the scope of the present invention.

It may be clearly understood by persons skilled in the art that, for the purpose of convenient and brief description, for a detailed working process of the foregoing system, apparatus, and unit, reference may be made to a corresponding process in the foregoing method embodiments, and details are not described here again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or part of the technical solutions may be implemented in the form of a software product. The computer software product is stored in a storage medium, and includes several instructions for instructing a computer device (which may be a personal computer, a server, a network device, and the like) to perform all or a part of the steps of the method described in the embodiment of the present invention. The storage medium includes: any medium that can store program code, such as a USB flash disk, a removable hard disk, a read-only memory (ROM, Read-Only Memory), a random access memory (RAM, Random Access Memory), a magnetic disk, or an optical disk.

The foregoing descriptions are merely exemplary embodiments of the present invention, but are not intended to limit the present invention. Any modifications, equivalent substitutions, and improvements made within the spirit and principle of the present invention shall fall within the protection scope of the present invention.

What is claimed is:

1. A generation and display method of a user interface, comprising:
determining an operable element of a user interface;
generating a transition relationship connected graph of the operable element; and
displaying the transition relationship connected graph in the user interface,

2. The method according to claim I, wherein the displaying the transition relationship connected graph in the user interface comprises:
displaying, in the user interface, a transition relationship connected graph of all operable elements.

3. The method according to claim 1, wherein the displaying the transition relationship connected graph in the user interface comprises:
displaying, in the user interface, a transition relationship connected graph of an operable element corresponding to a current focus.

4. The method according to claim 1, wherein the displaying the transition relationship connected graph in the user interface comprises:
receiving a display manner of the transition relationship connected graph, wherein the display manner of the transition relationship connected graph is input by a user, and displaying the transition relationship connected graph in the display manner selected by the user.

5. The method according to claim 1, wherein after the step of displaying the transition relationship connected graph in the user interface, the method further comprises:
concealing the transition relationship connected graph when it is detected that the user does not operate the user interface in a set time,

6. A user interface device, comprising:
a determining unit, configured to determine an operable element of a user interface;
a generating unit, configured to generate a transition relationship connected graph of the operable element; and
a displaying unit, configured to display the transition relationship connected graph in the user interface.

7. The device according to claim 6, wherein the displaying unit is configured to display, in the user interface, a transition relationship connected graph of all operable elements.

8. The device according to claim 6, wherein the displaying unit is configured to display, in the user interface, a transition relationship connected graph of an operable element corresponding to a current focus.

9. The device according to claim 6, wherein the displaying unit comprises:
a receiving module, configured to receive a display manner of the transition relationship connected graph, wherein the display manner of the transition relationship connected graph is input by a user; and
a displaying module, configured to display the transition relationship connected graph in the display manner selected by the user.

10. The device according to claim 6, further comprising:
a concealing unit, configured to conceal the transition relationship connected graph when it is detected that the user does not operate the user interface in a set time.
